(19) United States
(12) Patent Application Publication
(10) Pub. No.: US 2017/0161911 A1
(43) Pub. Date: Jun. 8, 2017

(54) SYSTEM AND METHOD FOR IMPROVED DISTANCE ESTIMATION OF DETECTED OBJECTS

(71) Applicant: Pilot AI Labs, Inc., Sunnyvale, CA (US)

(72) Inventors: Ankit Kumar, San Diego, CA (US); Brian Pierce, Santa Clara, CA (US); Elliot English, Stanford, CA (US); Jonathan Su, San Jose, CA (US)

(73) Assignee: Pilot AI Labs, Inc., Sunnyvale, CA (US)

(21) Appl. No.: 15/369,726

(22) Filed: Dec. 5, 2016

Related U.S. Application Data
(60) Provisional application No. 62/263,496, filed on Dec. 4, 2015.

(51) Int. Cl. G06T 7/20; G06K 9/62; G06T 7/00

(52) U.S. Cl. CPC G06T 7/2033; G06T 7/0085; G06T 7/004; G06K 9/6256

(57) ABSTRACT

According to various embodiments, a method for distance and velocity estimation of detected objects is provided. The method includes receiving an image that includes a minimal bounding box around an object of interest. The method also includes calculating a noisy estimate of the physical position of the object of interest relative to a source of the image. Last, the method includes producing a smooth estimate of the physical position of the object of interest using the noisy estimate.

### CROSS REFERENCE TO RELATED APPLICATIONS

This application claims priority under 35 U.S.C. §119(e) to U.S. Provisional Application No. 62/263,496, filed Dec. 4, 2015, entitled SYSTEM AND METHOD FOR IMPROVED DISTANCE ESTIMATION OF DETECTED OBJECTS, the contents of each of which are hereby incorporated by reference.

### TECHNICAL FIELD

The present disclosure relates generally to machine learning algorithms, and more specifically to distance estimation of detected objects.

### BACKGROUND

It is often useful to know the distance one is from a particular object or target. Systems have attempted to estimate the distance of an object using a camera using a variety of methods, e.g. lasers. However, lasers may have limited range and also may not be accurate for really close objects. Thus, there is a need for distance estimation of an object no matter how far the object is from the observer, as long as the object appears in a camera used by the observer.

### SUMMARY

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

In general, certain embodiments of the present disclosure provide techniques or mechanisms for improved object detection by a neural network. According to various embodiments, a method for distance and velocity estimation of detected objects is provided. The method includes receiving an image that includes a minimal bounding box around an object of interest. The method also includes calculating a noisy estimate of the physical position of the object of interest relative to a source of the image. Last, the method includes producing a smooth estimate of the physical position of the object of interest using the noisy estimate.

In another embodiment, a system for distance and velocity estimation of detected objects is provided. The system includes one or more processors, memory, and one or more programs stored in the memory. The one or more programs comprise instructions to receive an image. The image includes a minimal bounding box around an object of interest. The one or more programs also comprise instructions to calculate a noisy estimate the physical position of the object of interest to a source of the image and produce a smooth estimate of the physical position of the object of interest using the noisy estimate.

In yet another embodiment, a non-transitory computer readable medium is provided. The computer readable medium storing one or more programs comprising instructions to receive an image. The image includes a minimal bounding box around an object of interest. The one or more programs also comprise instructions to calculate a noisy estimate the physical position of the object of interest to a source of the image and produce a smooth estimate of the physical position of the object of interest using the noisy estimate.

### BRIEF DESCRIPTION OF THE DRAWINGS

The disclosure may best be understood by reference to the following description taken in conjunction with the accompanying drawings, which illustrate particular embodiments of the present disclosure.

FIG. 1 illustrates a particular example of distance and velocity estimation by a neural network, in accordance with one or more embodiments.

FIG. 2 illustrates an example of object recognition by a neural network, in accordance with one or more embodiments.

FIGS. 3A and 3B illustrate an example of a method for distance and velocity estimation of detected objects, in accordance with one or more embodiments.

FIG. 4 illustrates one example of a neural network system that can be used in conjunction with the techniques and mechanisms of the present disclosure in accordance with one or more embodiments.

### DETAILED DESCRIPTION OF PARTICULAR EMBODIMENTS

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

For example, the techniques of the present disclosure will be described in the context of particular algorithms. However, it should be noted that the techniques of the present disclosure apply to various other algorithms. In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

According to various embodiments, a method for distance and velocity estimation of detected objects is provided. The method includes receiving an image that includes a minimal bounding box around an object of interest. The method also includes calculating a noisy estimate of the physical position of the object of interest relative to a source of the image. Last, the method includes producing a smooth estimate of the physical position of the object of interest using the noisy estimate.

Example Embodiments

In various embodiments, a system is provided for estimating the physical distance and velocities of objects within a sequence of images relative to the camera which took the sequence of images. In some embodiments, it is assumed that for each image, there is a minimal bounding box around all objects of interest (e.g. a people's heads). Such bounding boxes may be output by a neural network detection system as described in the U.S. Patent Application entitled SYSTEM AND METHOD FOR IMPROVED GENERAL OBJECT DETECTION USING NEURAL NETWORKS filed on Nov. 30, 2016 which claims priority to U.S. Provisional Application No. 62/261,260, filed Nov. 30, 2015, of the same title, each of which are hereby incorporated by reference. In some embodiments, the system may also be informed of the approximate physical, diagonal size of the objects within the boxes (e.g. the diagonal across a minimal bounding box of an average person's head is 0.25 meters). In some embodiments, the sequence of boxes around the objects of interest is produced by neural networks.

In addition, the system provides tracking between the sequence of frames, so that the system can keep track of which box belongs to which instance of the object from one frame to the next. In various embodiments, such tracking may be performed by a tracking system as described in the U.S. Patent Application entitled SYSTEM AND METHOD FOR DEEP-LEARNING BASED OBJECT TRACKING filed on Dec. 2, 2016 which claims priority to U.S. Provisional Application No. 62/263,611, filed on Dec. 4, 2015, of the same title, each of which are hereby incorporated by reference. Because these boxes come from a neural network, there is inherently some noise associated with the box's size and position. The system produces smooth position and velocity estimates even if the sequence of boxes is noisy.

In various embodiments, an overview of the system for determining smooth position estimates is as follows. First, given a single image, the system produces a noisy estimate of the relative physical position (relative to the camera) of the each object within the image (for all the bounding boxes that are given). This noisy estimate is computed using the orientation of the camera, the size of the box within the image, and the known physical box size of that type of object.

Second, the noisy estimate is fed into the dynamical systems estimator which is able to produce accurate, smooth object positions and velocities given a sequence of noisy estimates. The sequence of noisy estimates is handled separately for each unique instance of an object within a sequence of images (e.g. for each individual person).

Calculating a noisy estimate of the physical position

The diagram below shows a sketch of a camera pointed at a physical object. Given the angle of the camera with the ground (denoted as θ), the field of view of the camera (denoted as a), the physical length of the diagonal across the box for an average instance of the object (denoted as s), the area of the box in pixels (denoted as A), and the height (H) and width (W) of the image in pixels, the system computes the straight-line distance d between the object and the camera as:

d=s/2* tan(A/2*α/H)

Once the system has the straight-line object distance d, the system computes the relative position (denoted as [symbol] (x [symbol] _0,x_1,x_2)) using the horizontal and vertical positions of the box center within the image (in pixels) (denoted as δ_w,δ_h):

(x_0,x_1,x_2)=(cos(θ−δ_h)*d,sin(δ_w)*d,- sin(θ−δ_h)*d)

Computing smooth estimates of object position and velocity

In various embodiments, as stated above, the position estimates which are computed purely based on the size and orientation of the box plus the geometry of the camera configuration are inherently noisy. This noise is due to noise in the box size and position, as well as noise in the camera angle (that measurement is only accurate to the nearest whole degree). To compensate for the noise in the system, the system uses a dynamical model of the object position and input the noisy estimates from above into the model to produce a smooth function which estimates the position and velocity which approximately fit the noisy data.

The model of the system is that the position of the object, as a function of time, is given by the equation:

_x(t)=_x_i+_(v_i)*t

where _x(t) is the vector of position of the object as a function of time, t is time, _x_i is the position of the object at some initial time, and _(v_i) is the velocity vector of the object at some initial time. If the system has n camera frames, the previous section gives a sequence of n measurements of the position _x(t) at times t_0,t_1, . . . , t_n. Substituting this data into the model provides a system of n equations which we can solve for the constants _x_i and _v_i. Having solved the system for the constants, we can then determine the position and velocity of the object at any time t, so long as t_0≦t≦t_n.

Application of the Model

In practice, the model is used in the following way. As new frames are received, the system stores a sequence of the previous n noisy position estimates (from above, based only on the box size and location and the geometry of the camera). Every time a new frame is received, the system computes the noisy estimate above and appends it to the list of position estimates, and discards the oldest estimate. After updating the list of estimates, the model is refitted using the new list. Then, until a new frame is received, the model is used to estimate the position.

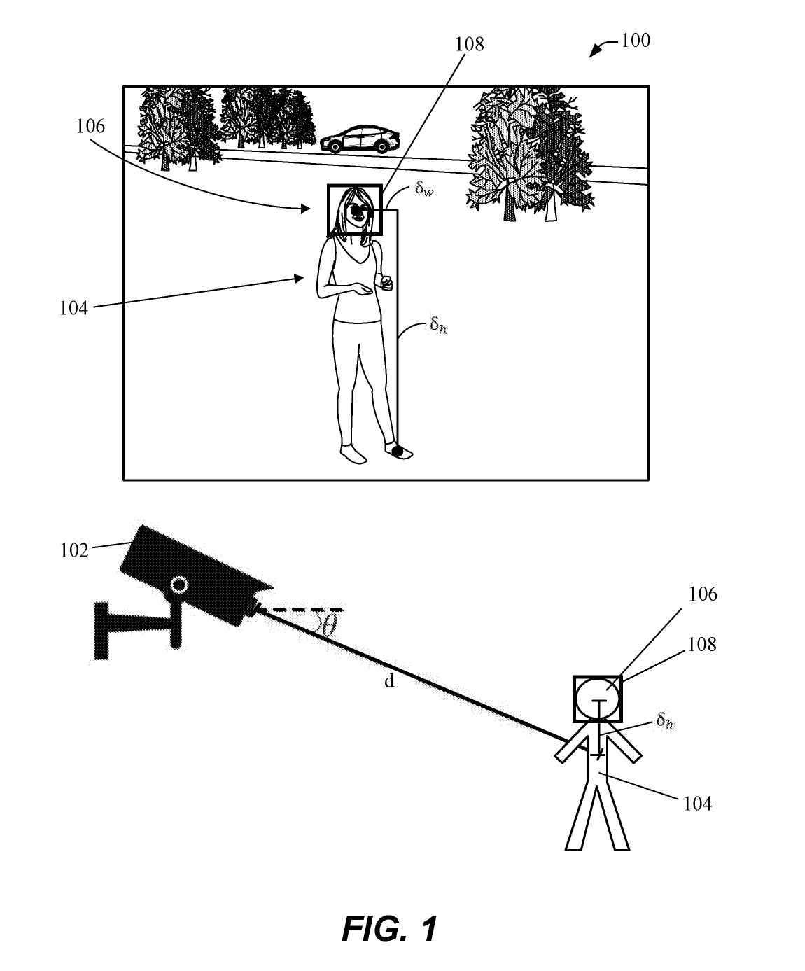

FIG. 1 illustrates some of the variables that are fed into the distance estimation algorithm. The input image 100 may be an image of a person 102. The input image 100 is passed through a neural network to produce a bounding box 108. As previously described, such bounding box may be produced by a neural network detection system as described in the U.S. Patent Application entitled SYSTEM AND METHOD FOR IMPROVED GENERAL OBJECT DETECTION USING NEURAL NETWORKS, referenced above. For purposes of illustration, box 108 may not be drawn to scale. Thus, although box 108 may represent smallest possible bounding boxe, for practical illustrative purposes, it is not literally depicted as such in FIG. 1. In some embodiments, the borders of the bounding boxes are only a single pixel in thickness and are only thickened and enhanced, as with box 108, when the bounding boxes have to be rendered in a display to a user, as shown in FIG. 1.

The image pixels within bounding box 108 is also passed through a neural network to associate each box with a unique identifier, so that the identity of each object within the box is coherent from one frame to the next (although only a single frame is illustrated in FIG. 1). As also previously described, such tracking of an object from one frame to the next may be performed by a tracking system as described in the U.S. Patent Application entitled SYSTEM AND METHOD FOR DEEP-LEARNING BASED OBJECT TRACKING, referenced above.

The location from the center of the bounding box to the center of the image is measured, for both the horizontal coordinate (δ_{w}) and the vertical coordinate (δₕ). The image 100 may be recorded by a camera 104. In some embodiments, camera 104 may be a camera attached to a drone. The angle θ that the camera makes with a horizontal line is depicted, as well as the straight-line distance d between the camera lens and the center of the image.

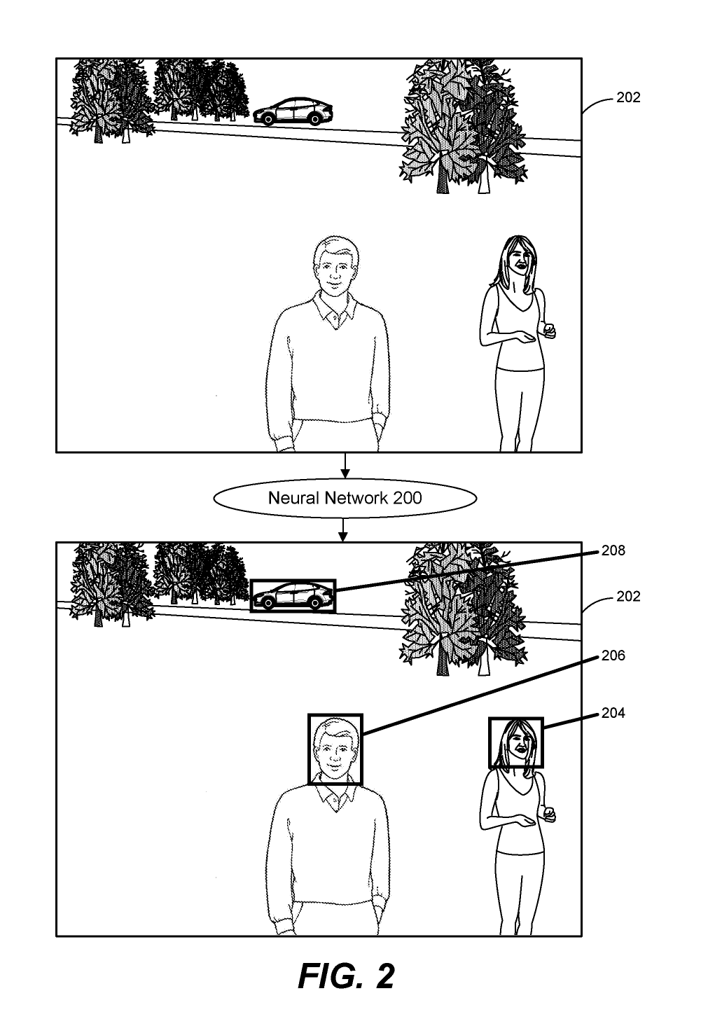

FIG. 2 illustrates an example of output boxes around objects of interest generated by a neural network 200, in accordance with one or more embodiments. According to various embodiments, the pixels of image 202 are input into neural network 200 as a third-order tensor. Once the pixels of image 202 have been processed by the computational layers within neural network 200, neural network 200 outputs a first order tensor with five dimensions corresponding to the smallest bounding box around the object of interest, including the x and y coordinates of the center of the bounding box, the height of the bounding box, the width of the bounding box, and a probability that the bounding box is accurate. As depicted in FIG. 2, neural network 200 has output boxes 204, 206, and 208. As previously described above, for purposes of illustration, boxes 204, 206, and 208 may not be drawn to scale. Boxes 204 and 206 each identify the face of a person. Box 208 identifies a car and may be a box from output by a separate recurrent step. Neural network 200 may be an example of a neural network detection system as described in the U.S. Patent Application entitled SYSTEM AND METHOD FOR IMPROVED GENERAL OBJECT DETECTION USING NEURAL NETWORKS, referenced above.

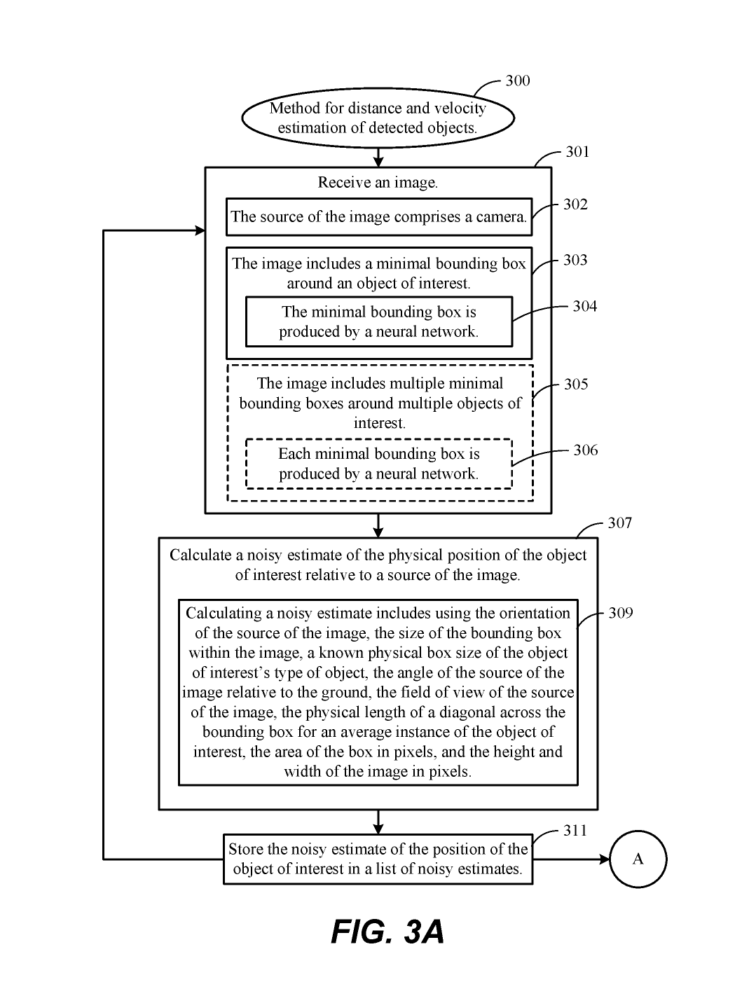

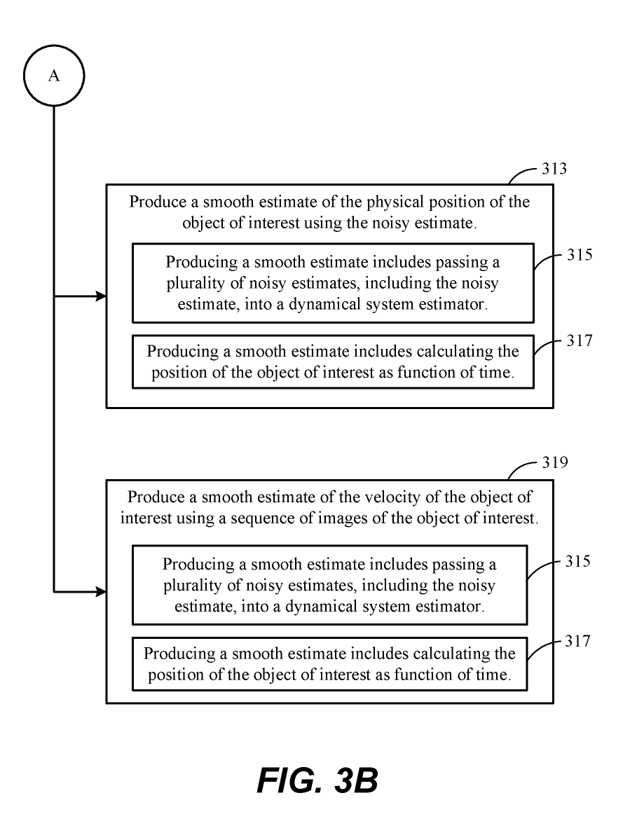

FIGS. 3A and 3B illustrate an example of a method 300 for distance and velocity estimation of detected objects. At 301, an image is received. In some embodiments, the source of the image may comprise a camera 302. The image includes a minimal bounding box 303 around an object of interest. In some embodiments, the minimal bounding box 303 may be produced by a neural network 304, such as neural network 200 described in FIG. 2. Alternatively, the image may include multiple minimal bounding boxes 305 around multiple objects of interest. Such minimal bounding boxes may also be produced by a neural network 306, such as neural network 200 described in FIG. 2.

At 307, a noisy estimate 309 of the physical position of the object of interest relative to a source of the image is calculated. In some embodiments, the source of the image may be camera 302. In various embodiments, calculating the noisy estimate 309 may include using the following values: the orientation of the source of the image, the size of the bounding box within the image, a known physical box size of the object of interest's type of object, the angle of the source of the image relative to the ground, the field of view of the source of the image, the physical length of a diagonal across the bounding box for an average instance of the object of interest, the area of the box in pixels, and the height and width of the image in pixels. In other embodiments, other values or fewer values may be used in calculating noisy estimate 309 of the physical position of the object of interest relative to the source of the image.

Noisy estimate 309 is then stored in a list of noisy estimates at 311. A subsequent image is then received at 301 and another noisy estimate 309 is calculated for the subsequent image and stored in the list of noisy estimate at 311. In some embodiments, steps 301 to 311 are repeated as long as an image is being captured by a source, such as camera 302, and sent to step 301.

Using the noisy estimates 309, a smooth estimate of the physical position of the object of interest is produced at 313. Additionally, using a sequence of images of the object of interest, a smooth estimate of the velocity of the object of interest is produced at 319. In some embodiments producing a smooth estimate at steps 313 and 319 includes passing a plurality of noisy estimates, including the noisy estimate, into a dynamical system estimator 315. In some embodiments, producing a smooth estimate at steps 313 and 319 further includes calculating the position 317 of the object of interest as a function of time.

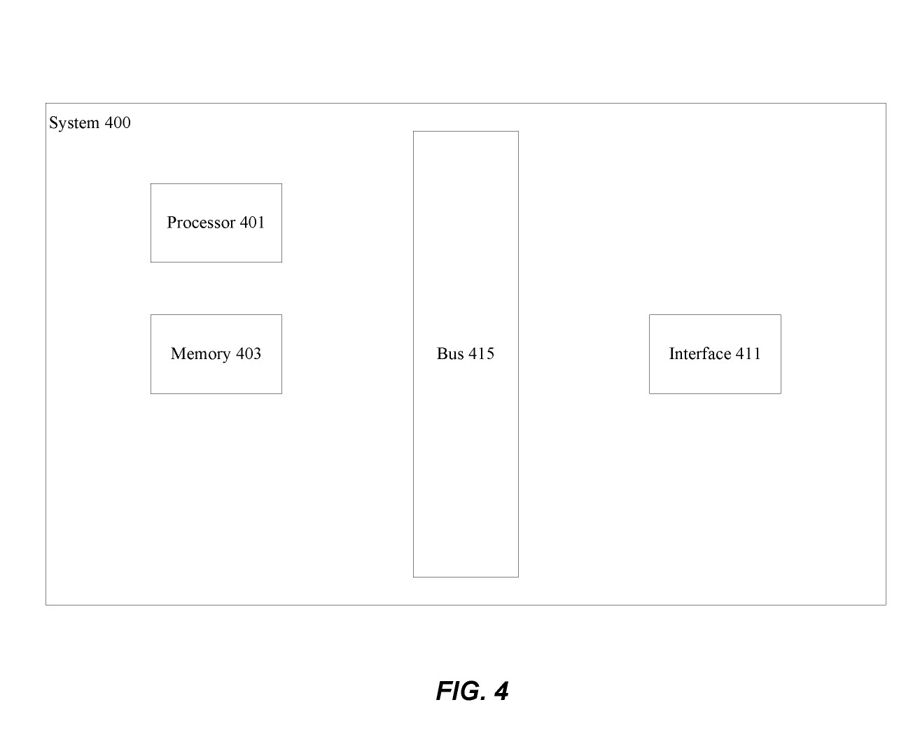

FIG. 4 illustrates one example of a neural network system 400, in accordance with one or more embodiments. According to particular embodiments, a system 400, suitable for implementing particular embodiments of the present disclosure, includes a processor 401, a memory 403, an interface 411, and a bus 415 (e.g., a PCI bus or other interconnection fabric) and operates as a streaming server. In some embodiments, when acting under the control of appropriate software or firmware, the processor 401 is responsible for various processes, including processing inputs through various computational layers and algorithms. Various specially configured devices can also be used in place of a processor 401 or in addition to processor 401. The interface 411 is typically configured to send and receive data packets or data segments over a network.

Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 400 uses memory 403 to store data and program instructions for operations including training a neural network, object detection by a neural network, and distance and velocity estimation. The program instructions may control the operation of an operating system and/or one or more applications, for example. The memory or memories may also be configured to store received metadata and batch requested metadata.

Because such information and program instructions may be employed to implement the systems/methods described herein, the present disclosure relates to tangible, or non-transitory, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

While the present disclosure has been particularly shown and described with reference to specific embodiments thereof, it will be understood by those skilled in the art that changes in the form and details of the disclosed embodiments may be made without departing from the spirit or scope of the present disclosure. It is therefore intended that the present disclosure be interpreted to include all variations and equivalents that fall within the true spirit and scope of the present disclosure. Although many of the components and processes are described above in the singular for convenience, it will be appreciated by one of skill in the art that multiple components and repeated processes can also be used to practice the techniques of the present disclosure.

What is claimed is:

1. A method for distance and velocity estimation of detected objects, the method comprising:
receiving an image, the image includes a minimal bounding box around an object of interest;
calculating a noisy estimate of the physical position of the object of interest relative to a source of the image; and
producing a smooth estimate of the physical position of the object of interest using the noisy estimate.

2. The method of claim 1, further comprising producing a smooth estimate of the velocity of the object of interest using a sequence of images of the object of interest.

3. The method of claim 1, wherein producing a smooth estimate includes passing a plurality of noisy estimates, including the noisy estimate, into a dynamical system estimator.

4. The method of claim 3, wherein calculating the noisy estimate includes using the orientation of the source of the image, the size of the bounding box within the image, and a known physical box size of the object of interest's type of object.

5. The method of claim 3, wherein calculating the noisy estimate includes using the angle of the source of the image relative to the ground, the field of view of the source of the image, the physical length of a diagonal across the bounding box for an average instance of the object of interest, the area of the box in pixels, and the height and width of the image in pixels.

6. The method of claim 1, wherein producing a smooth estimate includes calculating the position of the object of interest as a function of time.

7. The method of claim 1, further comprising:
storing the noisy estimate of the position of the object of interest in a list of noisy estimates;
receiving a new image, the new image including the object of interest;
calculating a new noisy estimate of the position of the object of interest using the new image; and
appending the new noisy estimate to the list of noisy estimates to be used for producing the smooth estimate.

8. The method of claim 1, wherein the image includes multiple minimal bounding boxes around multiple objects of interest.

9. The method of claim 1, wherein the source of the image comprises a camera.

10. The method of claim 1, wherein the minimal bounding box is produced by a neural network.

11. A system for distance and velocity estimation of detected objects, comprising:
one or more processors;
memory; and
one or more programs stored in the memory, the one or more programs comprising instructions for:
receiving an image, the image including a minimal bounding box around an object of interest;
calculating a noisy estimate the physical position of the object of interest to a source of the image; and
producing a smooth estimate of the physical position of the object of interest using the noisy estimate.

12. The system of claim 11, wherein the one or more programs further comprises instructions to produce a smooth estimate of the velocity of the object of interest using a sequence of images of the object of interest.

13. The system of claim 11, wherein producing a smooth estimate includes passing a plurality of noisy estimates, including the noisy estimate, into a dynamical system estimator.

14. The system of claim 13, wherein calculating the noisy estimate includes using the orientation of the source of the image, the size of the bounding box within the image, and a known physical box size of the object of interest's type of object.

15. The system of claim 13, wherein calculating the noisy estimate includes using the angle of the source of the image relative to the ground, the field of view of the source of the image, the physical length of a diagonal across the bounding box for an average instance of the object of interest, the area of the box in pixels, and the height and width of the image in pixels.

16. The system of claim 11, wherein producing a smooth estimate includes calculating the position of the object of interest as a function of time.

17. The system of claim 11, wherein the one or more programs further comprises instructions for:
storing the noisy estimate of the position of the object of interest in a list of noisy estimates;
receiving a new image, the new image including the object of interest;
calculating a new noisy estimate of the position of the object of interest using the new imaging; and
appending the new noisy estimate to the list of noisy estimates to be used for producing the smooth estimate.

18. The system of claim 11, wherein the image includes multiple bounding boxes around multiple objects of interest.

19. The system of claim 11, wherein the source of the image comprises a camera.

20. A non-transitory computer readable storage medium storing one or more programs configured for execution by a computer, the one or more programs comprising instructions for:
receiving an image, the image including a minimal bounding box around an object of interest;
calculating a noisy estimate the physical position of the object of interest to a source of the image; and
producing a smooth estimate of the physical position of the object of interest using the noisy estimate.
